(19) United States
(12) Patent Application Publication
(10) Pub. No.: US 2019/0042651 A1
(43) Pub. Date: Feb. 7, 2019

(54) SYSTEMS AND METHODS FOR CONTENT DISTRIBUTION

(71) Applicant: Facebook, Inc., Menlo Park, CA (US)

(72) Inventors: Li Ju, Issaquah, WA (US); Pawel Bara, Seattle, WA (US); Ramanathan Palaniappan, Issaquah, WA (US); Eric Carl Ertmann, San Francisco, CA (US); Jingxian Li, Redmond, WA (US); Jennifer Yin, San Francisco, CA (US)

(21) Appl. No.: 15/667,220

(22) Filed: Aug. 2, 2017

(51) Int. Cl. G06F 17/30; G06N 99/00

(52) U.S. Cl. CPC G06F 17/30867; G06F 17/30598; G06F 17/3089; G06N 99/005

(57) ABSTRACT

Systems, methods, and non-transitory computer-readable media can determine a set of posts associated with a group. One or more respective attributes can be determined for each of the posts. The posts can be categorized based at least in part on their respective attributes. One or more options for accessing the categorized posts can be provided through a page associated with the group, the page being accessible through a content provider system.

### FIELD OF THE INVENTION

The present technology relates to the field of content provision. More particularly, the present technology relates to techniques for distributing content.

### BACKGROUND

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

### SUMMARY

Various embodiments of the present disclosure can include systems, methods, and non-transitory computer readable media configured to determine a set of posts associated with a group; determine one or more respective attributes for each of the posts; categorize the posts based at least in part on their respective attributes; and provide one or more options for accessing the categorized posts through a page associated with the group, the page being accessible through a content provider system.

In an embodiment, the attributes for a post indicate at least one of: an author of the post, one or more users that were mentioned or tagged in the post, a geographic location associated with the post, one or more hashtags referenced in the post, whether the post includes images, whether the post includes videos, a type of response solicited by the post, or one or more types of user interactions received for the post.

In an embodiment, one or more attributes for a post indicate one or more topics that were predicted for the post using a machine learning model, the machine learning model being trained to predict the topics based at least in part on one or more content items included in the post.

In an embodiment, one or more attributes for a post indicate one or more topics that were predicted for the post using a machine learning model, the machine learning model being trained to predict the topics based at least in part on one or more terms included in the post.

In an embodiment, the systems, methods, and non-transitory computer readable media are configured to determine a set of topics based at least in part on attributes associated with the posts; determine that a first post among the set of posts corresponds to a first topic among the set of topics based at least in part on one or more attributes associated with the first post; and associate the first post with the first topic.

In an embodiment, the systems, methods, and non-transitory computer readable media are configured to determine that a threshold amount of posts in the set share at least one attribute and identify the at least one attribute as a topic.

In an embodiment, the systems, methods, and non-transitory computer readable media are configured to determine a plurality of posts that reference at least one hashtag and associate the plurality of posts with a topic corresponding to the at least one hashtag.

In an embodiment, the systems, methods, and non-transitory computer readable media are configured to determine a plurality of posts that originated from a given geographic location and associate the plurality of posts with a topic corresponding to the geographic location.

In an embodiment, the systems, methods, and non-transitory computer readable media are configured to determine a second set of posts that are similar to one another based at least in part on one or more attributes shared among the posts and associate the second set of posts with one another.

In an embodiment, the second set of posts at least originated from a shared geographic location or referenced one or more shared hashtags.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a group module, according to an embodiment of the present disclosure.

FIG. 2 illustrates an example categorization module, according to an embodiment of the present disclosure.

FIGS. 3A-3B illustrate example diagrams of a group page, according to an embodiment of the present disclosure.

FIGS. 4A-4B illustrate example diagrams of a group page, according to an embodiment of the present disclosure.

FIG. 5 illustrates an example process, according to various embodiments of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Distributing Content

People often utilize computing devices (or systems) for a wide variety of purposes. Users can use their computing devices to, for example, interact with one another, access content, share content, and create content. In some instances, users can interact with content that is published through a social networking system. Such content can include content items (e.g., images, videos, etc.), posts (e.g., text and media content items, such as images, videos, and audio), and pages.

Under conventional approaches, a user may navigate to or be presented with various pages in the social networking system. In some instances, a page may provide information that relates to a group. In general, a group may correspond to some organization of entities (e.g., users, businesses, etc.) formed for some purpose. For example, a group may be formed to discuss a certain topic, to discuss shared interests (e.g., hiking, volunteering, etc.), or to collaborate (e.g., a team collaborating on some project). In some instances, a group can be created through the social networking system by a user who serves as a moderator (or administrator) of the group. Once a group is created, a page corresponding to the group can be published through the social networking system. Users of the social networking system can interact with this page to access information relating to the group. In some instances, users may request to join the group as members. As members, these users may be granted rights to perform various operations and to view additional information. For example, a member of a given group can be permitted to post messages in a content feed (or news feed) associated with the group. These posts can be viewed by other members of the group. A group member may also be permitted to access and modify an events calendar associated with the group. Further, group members can be permitted to access content items (e.g., photos, videos, etc.) that were posted in the group's page. Since groups typically have no limit on membership count, it is not uncommon for membership counts to reach into the thousands. In such instances, it can be difficult to organize content (e.g., messages, media, etc.) shared by members through the group's page. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, a set of posts associated with a group can be determined. Further, attributes can be determined for each of the posts. These posts can be categorized based on their respective attributes. Once categorized, options for accessing the categorized posts through a page associated with the group can be provided. This page can be accessible through a content provider system (e.g., social networking system). More details describing the disclosed technology are provided below.

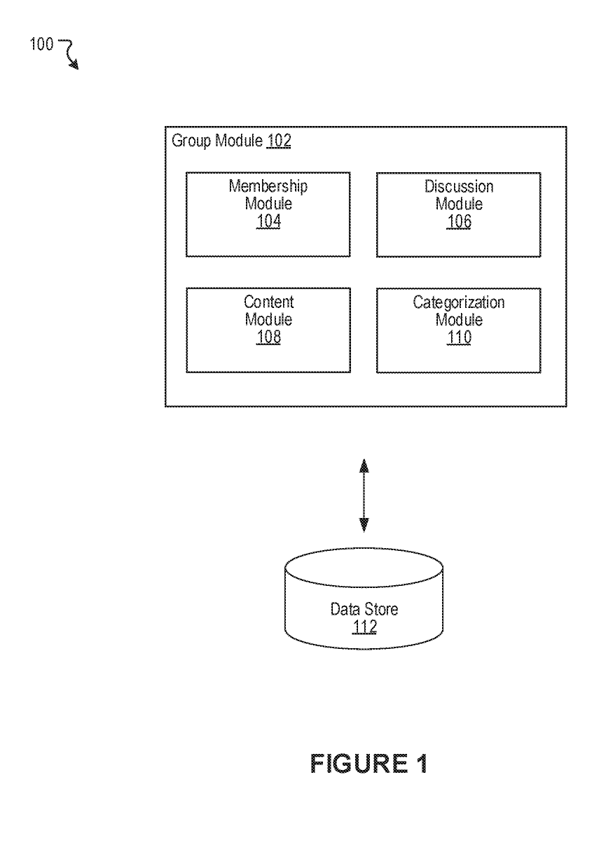

FIG. 1 illustrates an example system 100 including an example group module 102, according to an embodiment of the present disclosure. As shown in the example of FIG. 1, the example group module 102 can include a membership module 104, a discussion module 106, a content module 108, and a categorization module 110. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details.

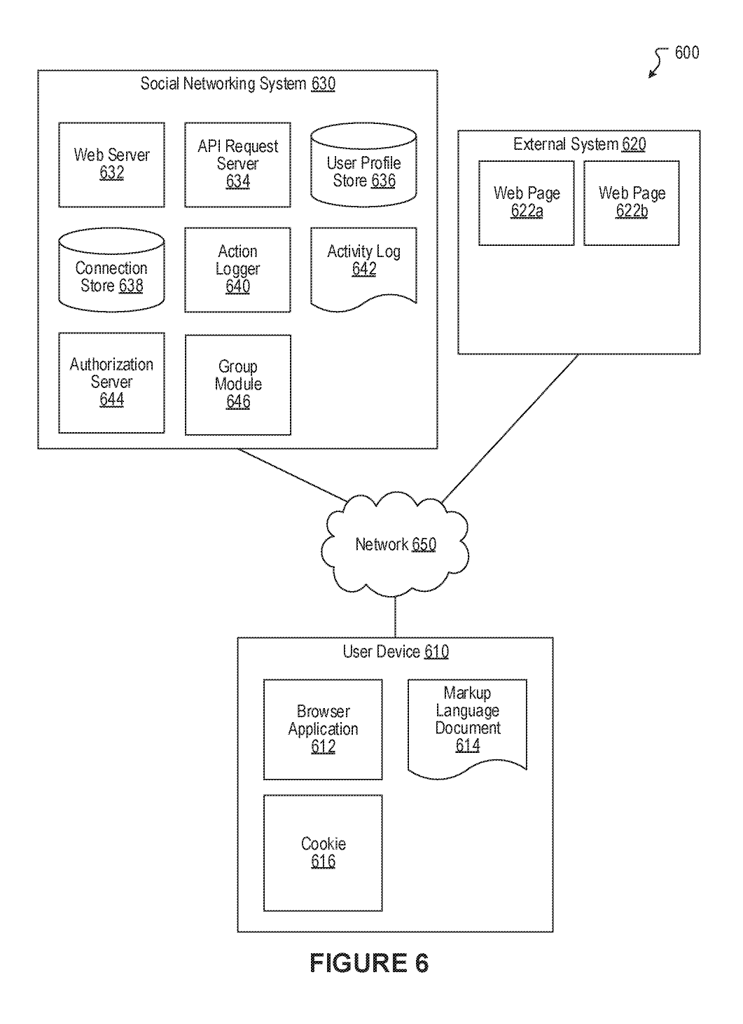

In some embodiments, the group module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the group module 102 can be implemented, in part or in whole, as software running on one or more computing devices or systems, such as on a user or client computing device. In one example, the group module 102 or at least a portion thereof can be implemented as or within an application (e.g., app), a program, or an applet, etc., running on a user computing device or a client computing system, such as the user device 610 of FIG. 6. In another example, the group module 102 or at least a portion thereof can be implemented using one or more computing devices or systems that include one or more servers, such as network servers or cloud servers. In some instances, the group module 102 can, in part or in whole, be implemented within or configured to operate in conjunction with a social networking system (or service), such as the social networking system 630 of FIG. 6.

The group module 102 can be configured to communicate and/or operate with the at least one data store 112, as shown in the example system 100. The at least one data store 112 can be configured to store and maintain various types of data needed by the group module 102, such as group names (or identifiers) and corresponding information describing members, posts, and post attributes, to name some examples. In some implementations, the at least one data store 112 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 112 can store information associated with users, such as user identifiers, user information, profile information, user specified settings, content produced or posted by users, and various other types of user data.

As mentioned, groups may be created through a content provider (e.g., the social networking system 630 of FIG. 6). For example, a user of the content provider may create a group directed to restaurants in the San Francisco Bay Area. This user can also serve as a moderator (or administrator) of the group. Once the group is created, a page corresponding to the group can be published through the content provider. This page can serve as an interface through which various information relating to the group can be accessed and shared. In some instances, certain features may be restricted to users that are members of the group (e.g., accessing information, posting content, etc.). In some embodiments, the membership module 104 can be configured to process user requests for joining groups. In general, the membership module 104 can determine when a user has requested to join a group as a member. The membership module 104 can send this request to any moderators (of administrators) of the group. Once a moderator has approved the request, the membership module 104 can identify the user as a member of the group. As a member, the user may be granted rights to access various features that are typically only available to group members. For example, the discussion module 106 can be configured to provide the user with access to one or more content feeds (or news feeds) associated with the group. In some embodiments, the discussion module 106 provides an option to post content in content feeds. A group member can select this option to post content through a given content feed. In this example, other members of the group can access the content feed to view the posted content. In some embodiments, the discussion module 106 can provide one or more options for interacting with posts published through content feeds. For example, group members can select an option to like a post, add a comment in response to a post, share a post, or react to a post, to name some examples. In some instances, posts may include content items (e.g., photos, videos, etc.). In some embodiments, when content items are posted, the content module 108 can store the content items in a gallery associated with the group. The content module 108 can also store respective information for each posted content item including, for example, information identifying any users that posted the content item and any posts in which the content item is included or referenced.

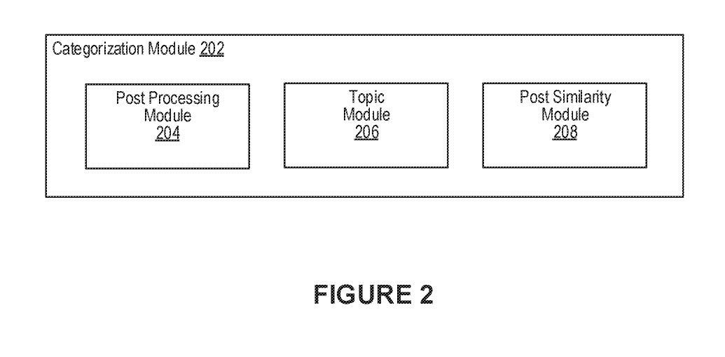

The categorization module 110 can be configured to categorize any posts associated with a given group. For example, the posts to be categorized may be published in a content feed associated with the group. In some embodiments, the categorization module 110 determines a set of topics being discussed among members of the group. In such embodiments, posts can be categorized into one or more topics. As a result, members can be provided with options for accessing posts relating to a specific topic. In some embodiments, posts can be categorized based on their similarity to one another. In such embodiments, members can access other posts that are related to the group and that are similar to a post of their choosing. More details regarding the categorization module 110 will be provided below with reference to FIG. 2.

FIG. 2 illustrates an example categorization module 202, according to an embodiment of the present disclosure. In some embodiments, the categorization module 110 of FIG. 1 can be implemented as the categorization module 202. As shown in FIG. 2, the categorization module 202 can include a post processing module 204, a topic module 206, and a post similarity module 208.

The post processing module 204 can be configured to determine various types of information for posts. In some embodiments, information corresponding to a given post may be stored as a set of attributes that each describe some aspect, or feature, of the post. For example, the post processing module 204 can determine respective attributes for each post that was published in a content feed associated with a group. In some embodiments, these post attributes can be used to categorize posts into topics. In some embodiments, the post attributes can be used to identify posts that are similar to one another. In general, the post processing module 204 can be configured to determine many types of attributes. However, both the type and number of attributes determined for a given post can vary depending on the implementation.

In some embodiments, the post processing module 204 can determine an author of a post. For example, a user “Jane Doe” that created the post can be identified. In such embodiments, this information can be used to categorize the post into a topic, a feed of similar posts, or both.

In some embodiments, the post processing module 204 can determine the identities of any users that were mentioned or tagged in a post. For example, the post may mention a user by name (or username). In this example, the post processing module 204 can determine an identity of the user mentioned in the post and this information can be used to categorize the post into a topic, a feed of similar posts, or both. In another example, the user may select an option to tag another user in the post. In this example, the post processing module 204 can determine an identity of the user tagged in the post and this information can be used to categorize the post into a topic, a feed of similar posts, or both.

In some embodiments, the post processing module 204 can determine a geographic location from which a post originated. This geographic location can be used to categorize the post into a topic, a feed of similar posts, or both. In general, any well-known approach for determining geolocation information may be used to determine a geographic location from which the post originated. In some instances, a geographic location for a post may be specified by a user that created the post. In some instances, the geographic location may be determined and provided by a software application (e.g., social networking application) running on the user's computing device.

In some embodiments, the post processing module 204 can identify any tags (e.g., hashtags) included (or mentioned) in a post. For example, a post may mention a hashtag “#sushi.” In this example, the post processing module 204 can use the hashtag “#sushi” to categorize the post into a topic, a feed of similar posts, or both.

In some embodiments, the post processing module 204 can determine topics that relate to a given post based on text included in the post. For example, in some embodiments, the post text can be provided to an entity extractor (e.g., topic tagger) for analysis. The entity extractor can provide a set of topics that were determined from the text as well as a respective value that indicates a likelihood, or confidence, with which a topic corresponds to the post's text. In some embodiments, topics having at least a threshold likelihood of correspondence can be used to categorize the post into a topic, a feed of similar posts, or both. In general, the entity extractor can be implemented using any generally known techniques for extracting topics from text.

As mentioned, posts may include content items (e.g., photos, videos, etc.). In some embodiments, the post processing module 204 can determine whether a post includes any images. For example, if the post includes one or more images, the post processing module 204 can categorize the post into a topic relating to images (e.g., “See posts that include images”). Similarly, if the post includes one or more videos, the post processing module 204 can categorize the post into a topic relating to videos.

In some instances, subject matter reflected in images included with a post may be used to categorize the post. For example, the post processing module 204 can analyze the images to identify individuals and/or concepts that are represented in the images. In some embodiments, the post processing module 204 can utilize a machine learning model (image classifier) to identify features (e.g., identities, or names, of individuals, objects, activities, products, logos, etc.) that are represented in the images. In such embodiments, features having at least a threshold likelihood of correspondence to the post can be used to categorize the post into a topic, a feed of similar posts, or both. In some embodiments, the image classifier can be trained using supervised training data that includes a sample set of images. The image classifier can be based on any machine learning technique, including but not limited to a deep convolutional neural network. Similar machine learning models can be utilized for identifying features (e.g., individuals, concepts, etc.) in other types of content such as videos and audio.

In some embodiments, users may create posts that solicit responses for some purpose. For example, a post may include a poll, ask for a recommendation, or ask a question. In such embodiments, the post processing module 204 can determine when a post was created to solicit responses for a given purpose. The post processing module 204 can use the type of response being solicited (e.g., poll, recommendation, question, etc.) to categorize the post into a topic, a feed of similar posts, or both. For example, a post that was created to poll members can be included in a content feed of other similar posts that that also include polls.

As mentioned, users can be provided options for interacting with posts published through content feeds. For example, a user can select an option to like a post, add a comment in response to a post, share a post, or react to a post (e.g., happy, sad, funny, etc.). In some embodiments, the post processing module 204 can determine any user interactions that were received for a given post. These user interactions can be used to categorize the post into a topic, a feed of similar posts, or both. For example, posts that received a threshold amount of user interactions of a given type can be categorized in the same topic (e.g., “Funny posts”, “Most liked”, “Most comments”, etc.). In some embodiments, the number of user interactions received for a post of some type can be used to rank that post. For example, a first post that received 1,000 “funny” reactions can be ranked higher than a second post that received 500 “funny” reactions.

The topic module 206 can determine a set of topics based on post attributes. In general, a topic may be identified using any of the attributes determined by the post processing module 204. In some embodiments, the topic module 206 can determine when a threshold amount (e.g., number, percentage) of posts in a group are associated with a given attribute. In such embodiments, this attribute can be identified as a topic in the group. Further, any post associated with the attribute can be categorized into the topic. This topic can then be surfaced as an option through a page corresponding to the group. A user can select the option to access posts in the group that are associated with the topic. For example, the topic module 206 can determine when a threshold amount (e.g., number, percentage) of posts in a group originated from a particular geographic location (e.g., Seattle, Wash.). In this example, the topic module 206 can identify the geographic location as a topic that is of interest to the group. The topic module 206 can also associate any post that originated from the geographic location with the identified topic.

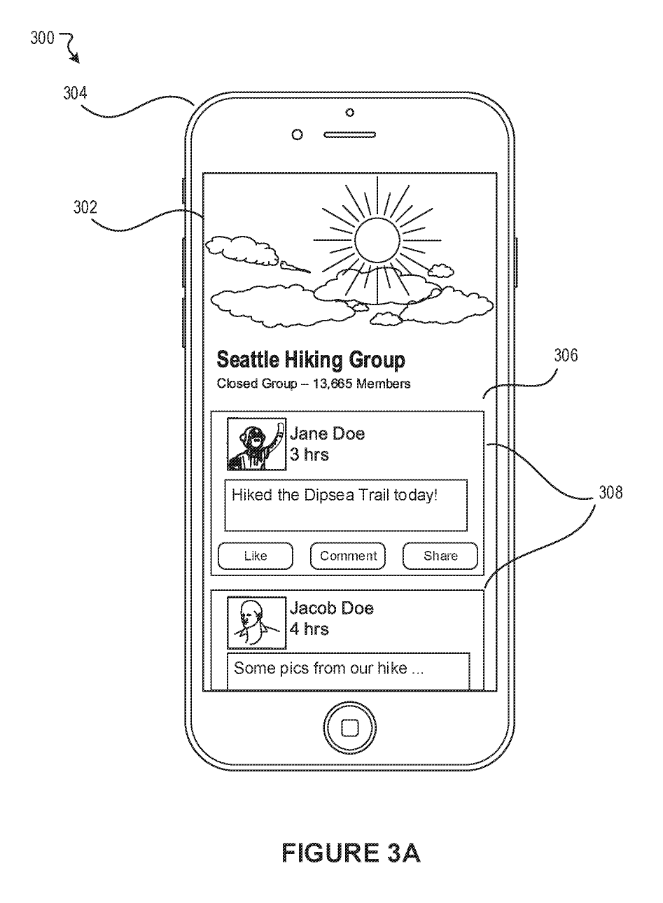

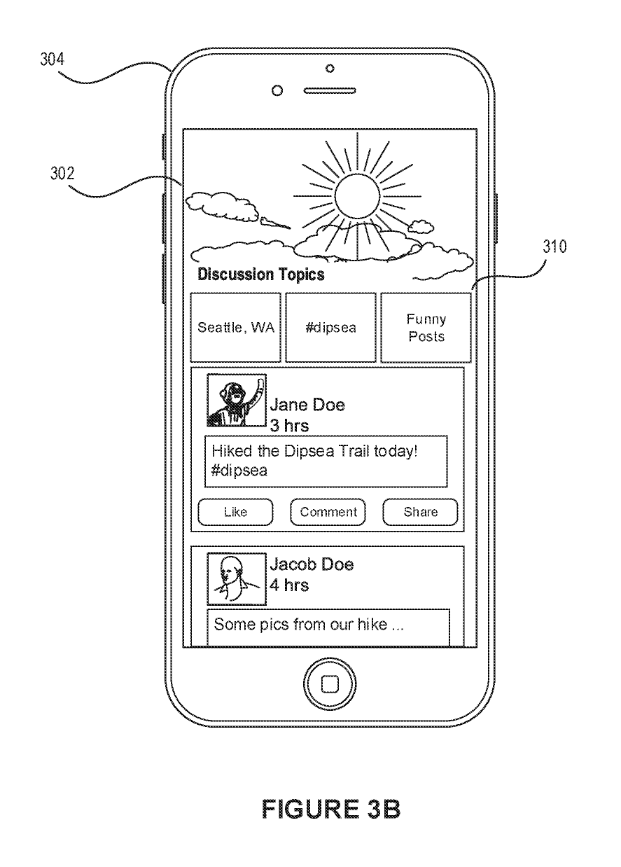

In some embodiments, multiple attributes can be used to identify a topic that is of interest to a group. For example, the topic module 206 can determine when a threshold amount (e.g., number, percentage) of posts in a group originated from a particular geographic location (e.g., Seattle, Wash.) and that included a particular hashtag (e.g., “#sushi”). In this example, the topic module 206 can identify the geographic location and the hashtag as a topic of interest to the group. The topic module 206 can then associate any post that originated from the geographic location and included the hashtag with the identified topic. As mentioned, group members can access posts categorized into a given topic by accessing an option through a page corresponding to the group, as illustrated in the example diagrams of FIGS. 3A-3B.

The post similarity module 208 can be configured to identify posts that are similar to one another. In some embodiments, a similarity between a pair of posts can be determined when the two posts share one or more attributes. For example, if a first post and a second post both reference a hashtag “sushi”, the post similarity module 208 can determine the first post and the second post are similar to one another. In such embodiments, a user that accesses the first post can be provided an option to access other posts that are similar to the first post. If this option is selected, the user can be shown a content feed which includes the second post among other similar posts.

In some embodiments, a number of attributes shared between a pair of posts can be used to measure a level (or amount) of similarity between the two posts. For example, a first post, second post, and third post may each reference a hashtag “sushi”. In this example, the first post and the second post may also be created by users that share a geographic location (e.g., Seattle, Wash.). Here, the first post and the second post share two attributes while the first post and the second post only have one attribute in common with the third post. As a result, the first post and the second post have a greater amount of similarity to each another than to the third post. In some embodiments, a level of similarity between posts can be used to rank posts. In the foregoing example, when generating a content feed of similar posts, the post similarity module 208 can rank both the first post and the second post higher than the third post. In some embodiments, a level of similarity between posts can be used as a threshold for determining which posts are included in a content feed of similar posts. For example, when generating a content feed of similar posts, the post similarity module 208 can require that posts share at least two attributes in order to be included in the content feed.

FIG. 3A illustrates an example diagram 300 of a group page 302, according to an embodiment of the present disclosure. The group page 302 may be presented on a display screen of a computing device 304. Further, the group page 302 may be provided through an application (e.g., a social networking application) running on the computing device 304. The user operating the computing device 304 can interact with the group page 302 to access various information relating to the group including, for example, a content feed 306 associated with the group. The content feed 306 can include posts 308 that were created by members (or users) of the group. In some embodiments, these posts 308 can be categorized into one or more topics as described above. In such embodiments, these topics 310 can be provided as options in the page 302, as illustrated in the example of FIG. 3B. A user can select any of these topics 310 to access posts that were categorized in that topic. In some embodiments, posts categorized in a given topic can be presented in a separate content feed that corresponds to that topic.

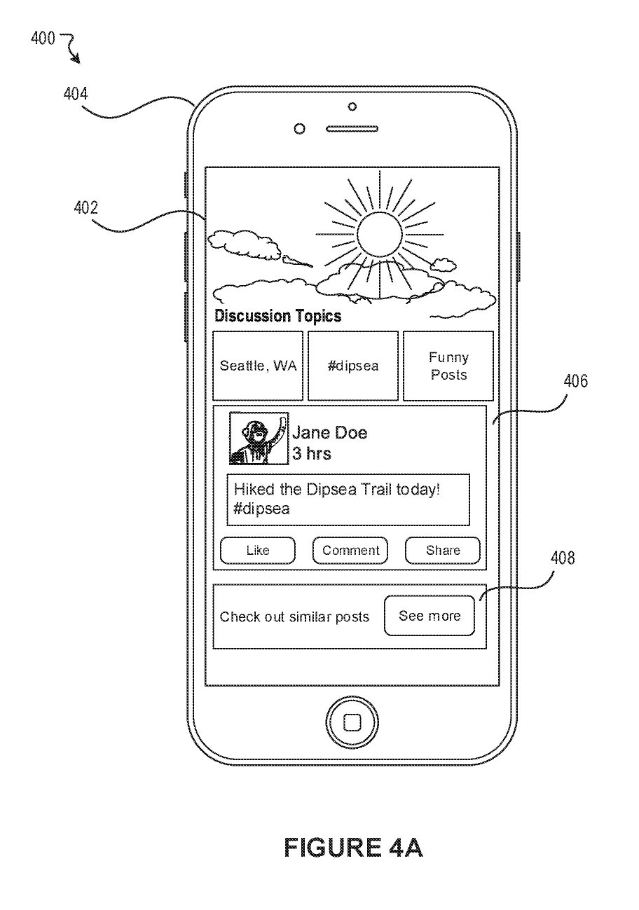

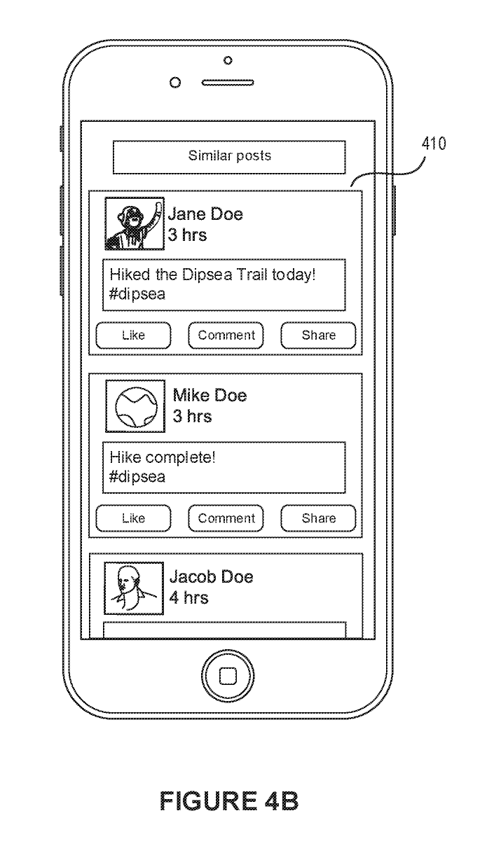

FIG. 4A illustrates an example diagram 400 of a group page 402, according to an embodiment of the present disclosure. The group page 402 may be presented on a display screen of a computing device 404. Further, the group page 402 may be provided through an application (e.g., a social networking application) running on the computing device 404. As mentioned, a user operating the computing device 404 can interact with the group page 402 to access various information relating to the group including, for example, a content feed 406 associated with the group. In some embodiments, posts in the content feed 406 can be categorized based on their similarity to one another. In such embodiments, an option 408 to access posts that are similar to a post 406 being accessed can be provided in the group page 402. The user can select the option 408 to access a content feed including posts that are similar to the post 406, as illustrated in the example of FIG. 4B. In some embodiments, posts similar to the post 406 can be presented in a separate content feed 410 that is dedicated to those similar posts as shown in the example of FIG. 4B.

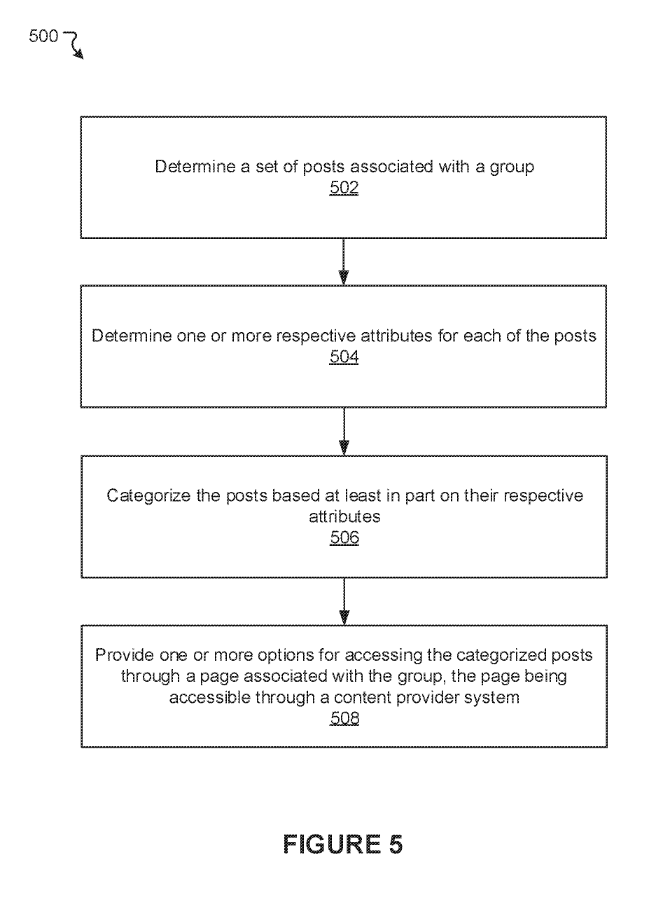

FIG. 5 illustrates an example process, according to various embodiments of the present disclosure. It should be appreciated that there can be additional, fewer, or alternative steps performed in similar or alternative orders, or in parallel, within the scope of the various embodiments discussed herein unless otherwise stated.

At block 502, a set of posts associated with a group are determined. At block 504, one or more respective attributes for each of the posts are determined. At block 506, the posts can be categorized based at least in part on their respective attributes. At block 508, one or more options for accessing the categorized posts through a page associated with the group can be provided. The page can be accessible through a content provider system.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a group module 646. The group module 646 can, for example, be implemented as the group module 102 of FIG. 1. As discussed previously, it should be appreciated that there can be many variations or other possibilities.

### Hardware Implementation

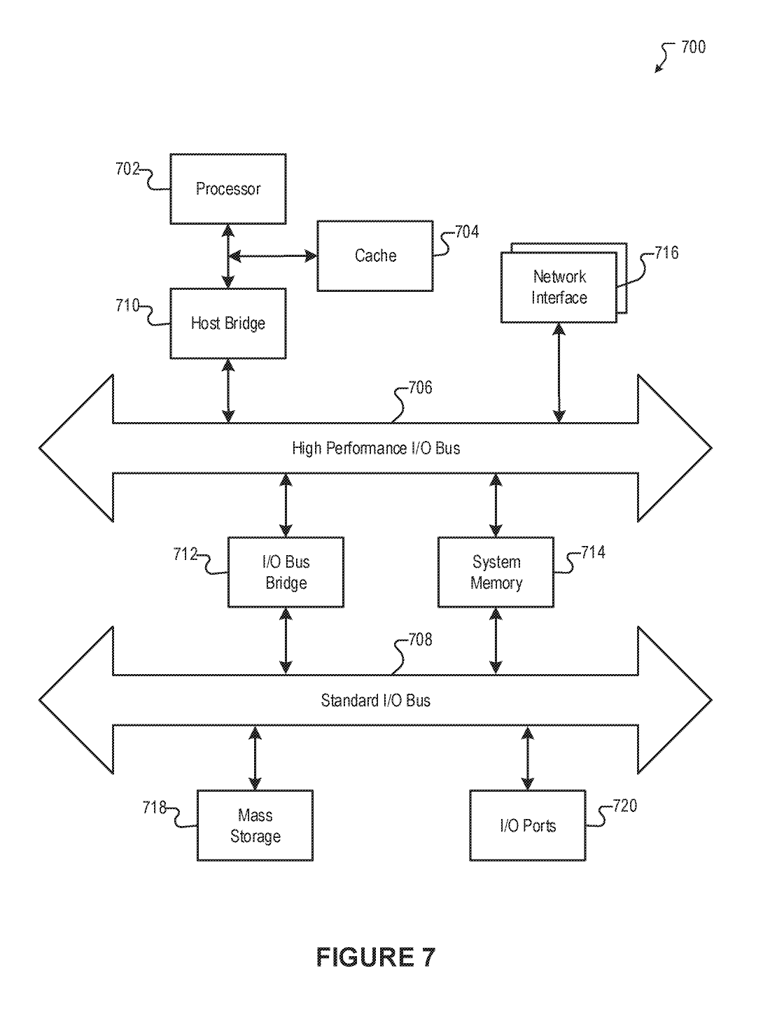

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, a set of posts associated with a group;
determining, by the computing system, one or more respective attributes for each of the posts;
categorizing, by the computing system, the posts based at least in part on their respective attributes; and
providing, by the computing system, one or more options for accessing the categorized posts through a page associated with the group, the page being accessible through a content provider system.

2. The computer-implemented method of claim 1, wherein the attributes for a post indicate at least one of: an author of the post, one or more users that were mentioned or tagged in the post, a geographic location associated with the post, one or more hashtags referenced in the post, whether the post includes images, whether the post includes videos, a type of response solicited by the post, or one or more types of user interactions received for the post.

3. The computer-implemented method of claim 1, wherein one or more attributes for a post indicate one or more topics that were predicted for the post using a machine learning model, the machine learning model being trained to predict the topics based at least in part on one or more content items included in the post.

4. The computer-implemented method of claim 1, wherein one or more attributes for a post indicate one or more topics that were predicted for the post using a machine learning model, the machine learning model being trained to predict the topics based at least in part on one or more terms included in the post.

5. The computer-implemented method of claim 1, wherein categorizing the posts based at least in part on their respective attributes further comprises:
determining, by the computing system, a set of topics based at least in part on attributes associated with the posts;
determining, by the computing system, that a first post among the set of posts corresponds to a first topic among the set of topics based at least in part on one or more attributes associated with the first post; and
associating, by the computing system, the first post with the first topic.

6. The computer-implemented method of claim 5, wherein determining the set of topics based at least in part on attributes associated with the posts further comprises:
determining, by the computing system, that a threshold amount of posts in the set share at least one attribute; and
identifying, by the computing system, the at least one attribute as a topic.

7. The computer-implemented method of claim 1, wherein categorizing the posts based at least in part on their respective attributes further comprises:
determining, by the computing system, a plurality of posts that reference at least one hashtag; and
associating, by the computing system, the plurality of posts with a topic corresponding to the at least one hashtag.

8. The computer-implemented method of claim 1, wherein categorizing the posts based at least in part on their respective attributes further comprises:
determining, by the computing system, a plurality of posts that originated from a given geographic location; and
associating, by the computing system, the plurality of posts with a topic corresponding to the geographic location.

9. The computer-implemented method of claim 1, wherein categorizing the posts based at least in part on their respective attributes further comprises:
determining, by the computing system, a second set of posts that are similar to one another based at least in part on one or more attributes shared among the posts; and
associating, by the computing system, the second set of posts with one another.

10. The computer-implemented method of claim 9, wherein the second set of posts at least originated from a shared geographic location or referenced one or more shared hashtags.

11. A system comprising:
at least one processor; and
a memory storing instructions that, when executed by the at least one processor, cause the system to perform:
determining a set of posts associated with a group;
determining one or more respective attributes for each of the posts;
categorizing the posts based at least in part on their respective attributes; and
providing one or more options for accessing the categorized posts through a page associated with the group, the page being accessible through a content provider system.

12. The system of claim 11, wherein the attributes for a post indicate at least one of: an author of the post, one or more users that were mentioned or tagged in the post, a geographic location associated with the post, one or more hashtags referenced in the post, whether the post includes images, whether the post includes videos, a type of response solicited by the post, or one or more types of user interactions received for the post.

13. The system of claim 11, wherein one or more attributes for a post indicate one or more topics that were predicted for the post using a machine learning model, the machine learning model being trained to predict the topics based at least in part on one or more content items included in the post.

14. The system of claim 11, wherein one or more attributes for a post indicate one or more topics that were predicted for the post using a machine learning model, the machine learning model being trained to predict the topics based at least in part on one or more terms included in the post.

15. The system of claim 11, wherein categorizing the posts based at least in part on their respective attributes further causes the system to perform:
determining a set of topics based at least in part on attributes associated with the posts;
determining that a first post among the set of posts corresponds to a first topic among the set of topics based at least in part on one or more attributes associated with the first post; and
associating the first post with the first topic.

16. A non-transitory computer-readable storage medium including instructions that, when executed by at least one processor of a computing system, cause the computing system to perform a method comprising:
determining a set of posts associated with a group;
determining one or more respective attributes for each of the posts;
categorizing the posts based at least in part on their respective attributes; and
providing one or more options for accessing the categorized posts through a page associated with the group, the page being accessible through a content provider system.

17. The non-transitory computer-readable storage medium of claim 16, wherein the attributes for a post indicate at least one of: an author of the post, one or more users that were mentioned or tagged in the post, a geographic location associated with the post, one or more hashtags referenced in the post, whether the post includes images, whether the post includes videos, a type of response solicited by the post, or one or more types of user interactions received for the post.

18. The non-transitory computer-readable storage medium of claim 16, wherein one or more attributes for a post indicate one or more topics that were predicted for the post using a machine learning model, the machine learning model being trained to predict the topics based at least in part on one or more content items included in the post.

19. The non-transitory computer-readable storage medium of claim 16, wherein one or more attributes for a post indicate one or more topics that were predicted for the post using a machine learning model, the machine learning model being trained to predict the topics based at least in part on one or more terms included in the post.

20. The non-transitory computer-readable storage medium of claim 16, wherein categorizing the posts based at least in part on their respective attributes further causes the computing system to perform:
determining a set of topics based at least in part on attributes associated with the posts;
determining that a first post among the set of posts corresponds to a first topic among the set of topics based at least in part on one or more attributes associated with the first post; and
associating the first post with the first topic.
